(19) United States
(12) Patent Application Publication
(10) Pub. No.: US 2025/0346276 A1
(43) Pub. Date: Nov. 13, 2025

(54) STROLLER WAGON WITH EASY DISASSEMBLY AND ASSEMBLY FEATURES

(71) Applicant: New Century Products Co., Ltd., Taipei City (TW)

(72) Inventor: Fu-Tsun LIN, Taipei City (TW)

(21) Appl. No.: 18/946,408

(22) Filed: Nov. 13, 2024

(30) Foreign Application Priority Data
May 7, 2024 (CN) 202420971465.0

(51) Int. Cl. B62B 7/08; B62B 9/14

(52) U.S. Cl. CPC B62B 7/083; B62B 9/142; B62B 2205/003

(57) ABSTRACT

A children's stroller with easy disassembly and assembly features are provided. The stroller includes a frame, a wheel module disposed below the frame, and a stroller module disposed above the frame. The frame cooperates with the wheel module via the stroller module to move. By disposing connecting buckle at the front and rear ends of the first and second side frames, and providing connection slots on the front and rear support rods, the front and rear support rods are detachably disposed at the front and rear ends of the first and second side frames by fitting the connection slots and connection locking blocks. When it is necessary to carry items, the front or rear support rod can be detached to forming an opening at the front or rear side of the side frame that connects to the storage space.

### CROSS REFERENCE TO RELATED APPLICATIONS

This Application claims priority of China Patent Application No. 202420971465.0, filed on May 7, 2024, the entirety of which is incorporated by reference herein.

### BACKGROUND OF THE INVENTION

### Field of the Invention

The present invention relates to strollers, and, in particular, to a stroller wagon with easy disassembly and assembly features.

### Description of the Related Art

A children's stroller is a rideable stroller designed for infants and children. It allows parents to reduce the burden of holding or carrying their child while out. And it also provides better comfort and safety for the child during outings. To further improve the comfort of the child in the stroller, current strollers have a larger accommodating space on the frame, and then the space is enclosed by fabric. The child is placed in the accommodating space, so the child can sit, lie down, or play with toys according to his or her preferences. Parents can push the frame using a handlebar at the top of the frame and the wheels below the frame.

The typical scenarios where strollers are used include places like parks, supermarkets, and shopping malls. In real-life situations, children may experience separation anxiety and require frequent interactions with their parents by being lifted out of the stroller sometimes. However, the stroller still needs to be continuously pushed to move, particularly when carrying purchased items. The items can be placed in the accommodating space to reduce the burden of holding these items. The front or rear bars of the frame of current strollers cannot be disassembled during using. When the stroller is used for carrying items, the frame cannot be disassembled and reassembled to adjust the frame, so the parent cannot take care of the child and the items at a same time. Therefore, there is a need for improvement.

### BRIEF SUMMARY OF THE INVENTION

The main objective of this disclosure is to propose a children's stroller with easy disassembly and assembly features, and particularly to a children's stroller with easy disassembly and assembly features according to different requirements.

To achieve this purpose, the disclosure provides a children's stroller with easy disassembly and assembly features, including a frame, a wheel module is disposed under the frame, and a stroller module is disposed above the frame, the frame moves through applying force to the stroller module to move in corporation with the wheel module, the frame includes a front support rod, a rear support rod, a first side frame, and a second side frame, the first side frame and the second side frame are parallel to each other and spaced apart from each other, upper ends of the first side frame and the second side frame include connecting buckle, and the connecting buckles on the same ends of the first side frame and the second side frame correspond to each other, the ends of the front support rod and the rear support rod include connecting grooves corresponding to the connecting buckles, the front support rod and the rear support rod are detachably disposed on a front side and a rear side of the first side frame and the second side frame, respectively, through the corporation of the connecting grooves and the connecting buckles; a plurality of auxiliary brackets are connected to and below the first side frame and the second side frame, the auxiliary brackets are transversely disposed between the first side frame and the second side frame, the auxiliary brackets are spaced apart from each other to form an accommodating space having an upward-facing opening on the frame; an auxiliary clamping buckle and an auxiliary item-carrying frame are disposed on the first side frame and the second side frame, the auxiliary clamping buckle is coaxially aligned with the connecting buckle in a vertical direction, the auxiliary clamping buckle is below the connecting buckle, the auxiliary item-carrying frame is detachably connected to the auxiliary clamping buckle, when the auxiliary item-carrying frame connects to the auxiliary clamping buckle, the auxiliary item-carrying frame extends to a front side and/or a rear side of the frame to form an auxiliary item-carrying space connected to the accommodating space.

In particular, both of the front support rod and the rear support rod include a rod body and connectors on both ends of the rod body, a connecting groove is formed on an external side of the connector, a connecting guide recess is provided on a side of the connecting buckle, a connecting opening is formed below the connector, and the connecting opening connects to the connecting groove, the connector is fitted onto the connecting buckle from top to bottom through the connection guide recess via the connecting opening formed on the connecting groove.

In particular, an engaging groove is formed at a side of the connecting buckle an engaging block which matches the engaging groove is disposed in the connecting groove, an engaging transmission element is fitted on the rod body, the engaging transmission element is transmissively connected to the engaging block, the engaging transmission element drives the engaging block to connect to the engaging groove or to detach from the engaging groove.

In particular, the auxiliary item-carrying frame includes an item-carrying support rod and connecting blocks disposed at both ends of the item-carrying support rod, an auxiliary groove is provided at a side of the connecting block that faces the auxiliary clamping buckle, the item-carrying support rod is connected to the auxiliary clamping buckle through the auxiliary grooves formed on the connecting blocks.

In particular, the item-carrying support rod includes a connecting portion and a support portion, the connecting portion includes an installing portion and a bending portion, the bending portion is above the installing portion, the bending portion extends towards one side of the installing portion, the support portion is disposed on the side of the bending portion that extends outwardly, an installing groove is provided on the connecting block, and the installing groove has an opening facing upwardly, the installing portion is disposed in the installing groove and connected to the installing block by external screws.

In particular, both of the first side frame and the second side frame include two fixed brackets and a movable bracket, the movable bracket is disposed between the two fixed brackets, sides of the two fixed brackets on the side facing each other has assembly portions, and two ends of the movable bracket are pivoted to the assembly portions the two fixed brackets on the same side are disposed opposite each other, a connecting buckle is disposed on one side adjacent to the assembly portion and positioned on the side of the two fixed brackets opposite each other.

In particular, the movable bracket has an H shape and includes a main support rod, an upper movable bracket is disposed over the main support rod, and a lower movable bracket is disposed below the main support rod, a stroller folding button is disposed on the main support rod and is transmissively connected to the upper movable bracket, and the frame is folded by pressing the stroller folding button.

In particular, the upper movable bracket includes a first movable support rod and a second movable support rod, and the lower movable bracket includes a third movable support rod and a fourth movable support rod, the first movable support rod and the third movable support rod are both disposed on the front side of the main support rod, and the second movable support rod and the fourth movable support rod are both disposed on the rear side of the main support rod, front ends of the first movable support rod and the third movable support rod are respectively hinged to the assembly portions, and rear ends of the first movable support rod and the third movable support rod are respectively hinged to the front side of the main support rod, front ends of the second movable support rod and the fourth movable support rod are respectively hinged to the rear side of the main support rod, and rear ends of the second movable support rod and the fourth movable support rod are respectively hinged to the assembly portions.

In particular, the stroller folding button includes a folding fixed switch and a folding movable block, the folding fixed switch is affixed above the main support rod, the folding movable block is movably fitted onto the main support rod, two folding control support rods respectively connect to the first movable support rod and the second movable support rod, and the folding control support rods are disposed on the folding movable block, one side of the folding movable block facing the folding fixed switch as a folding groove, and a side of the folding fixed switch facing the folding movable block includes a folding protrusion that fits into the folding groove, a control protrusion is disposed on a side of the folding fixed switch away from the folding protrusion, and the control folding protrusion is separated from the folding groove, when the folding movable block is connected to the folding fixed switch, the folding protrusion is positioned in the folding groove, and the two folding control support rods respectively support the first movable support rod and the second movable support rod to unfold the frame, when the folding movable block is separated from the folding fixed switch, the folding protrusion is separated from the folding groove, the folding movable block moves on the main support rod in a direction away from the folding fixed switch and simultaneously drives the two folding control support rods to move, which drives the first movable support rod and the second movable support rod to bend and fold to fold the frame.

In particular, the wheel module includes two front wheel assemblies and two rear wheel assemblies, the two front wheel assemblies are disposed independently, and each of the front wheel assemblies has a first quick connector disposed above, lower front ends of the first side frame and second side frame are disposed at first quick-connect slots that correspond with the first quick connectors, each of the two front wheel assemblies is clipped to the sides of the front end of the frame via the first quick connectors and the first quick-connect slots, a brake control rod connects the two rear wheel assemblies, and second quick connectors are disposed above each of the rear wheel assemblies, second quick-connect slots that correspond with the second quick connectors are disposed below rear ends of the first side frame and the second side frame, the two rear wheel assemblies are respectively connected to both sides of the rear end of the frame by engaging the second quick connectors with the second quick-connect slots.

By disposing connecting buckle at the front and rear ends of the first and second side frames, and providing connection slots on the front and rear support rods, the front and rear support rods are detachably disposed at the front and rear ends of the first and second side frames by fitting the connection slots and connection locking blocks. When it is necessary to carry items, the front or rear support rod can be detached to forming an opening at the front or rear side of the side frame that connects to the storage space. An auxiliary item-carrying frame is connected to the auxiliary clamping buckle at the opening to create an auxiliary item-carrying space on the frame, which facilitates placing items or simultaneously placing both items and a child.

### BRIEF DESCRIPTION OF THE DRAWINGS

FIG. 1 is a perspective structural view of the present disclosure.

FIG. 2 is another perspective structural view of the present disclosure.

FIG. 3 is an enlarged view of a section A from FIG. 2.

FIG. 4 is an exploded view showing the disassembly state of the front support rod and the fixed support of the present disclosure.

FIG. 5 is an enlarged view of a section B from FIG. 4.

FIG. 6 is a perspective structural view of the movable support of the present disclosure.

FIG. 7 is a perspective structural view of the load-bearing auxiliary rack of the present disclosure.

FIG. 8 is an exploded view showing the disassembly state of the load-bearing auxiliary rack of the present disclosure.

The reference numbers include frame 10, front support rod 11, rear support rod 12, rod body 121, connector 122, connecting groove 123, engaging block 124, engaging transmission element 125, first side frame 13, second side frame 14, fixed bracket 141, movable bracket 142, main support rod 1421, upper movable bracket 1422, first movable support rod 14221, second movable support rod 14222, lower movable bracket 1423, third movable support rod 14231, fourth movable support rod 14232, folding fixed switch 1424, folding movable block 1425, folding control support rod 1426, assembly portion 143, connecting buckle 144, engaging groove 145, auxiliary clamping buckle 15, auxiliary item-carrying frame 16, item-carrying support rod 161, connecting portion 1611, installing portion 16111, bending portion 16112, support portion 1612, connecting block 162, auxiliary groove 163, installing groove 164, auxiliary bracket 17, canopy lifting lock 18, canopy bracket 19, wheel module 20, front wheel assembly 21, rear wheel assembly 22, stroller module 30.

### DETAILED DESCRIPTION OF THE INVENTION

Aspects of the present disclosure are best understood from the following detailed description when read with the accompanying figures. It is evident that the described embodiments are merely a part of the present disclosure's embodiments and not all of them. Based on the embodiments of this disclosure, all other embodiments that can be obtained by ordinary skilled persons in the art without any creative work fall within the scope of this disclosure.

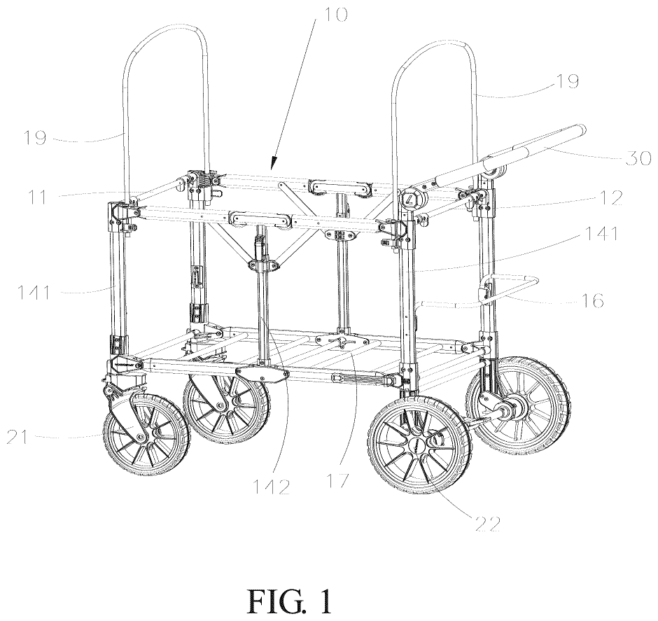

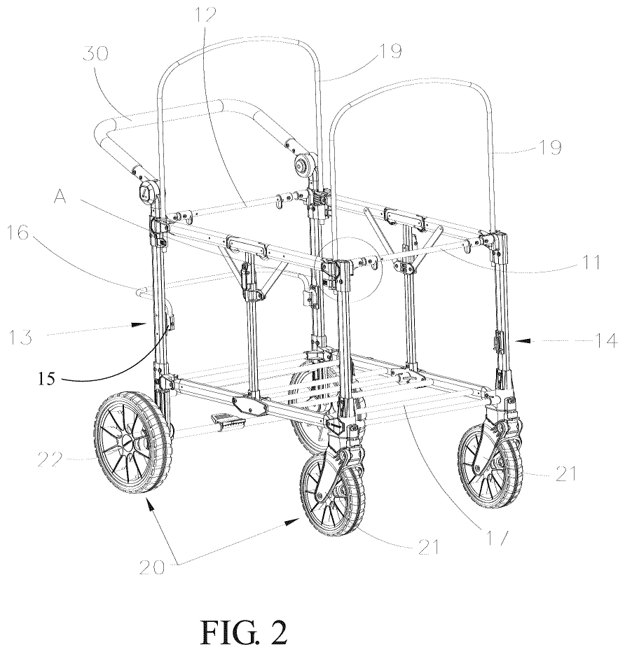

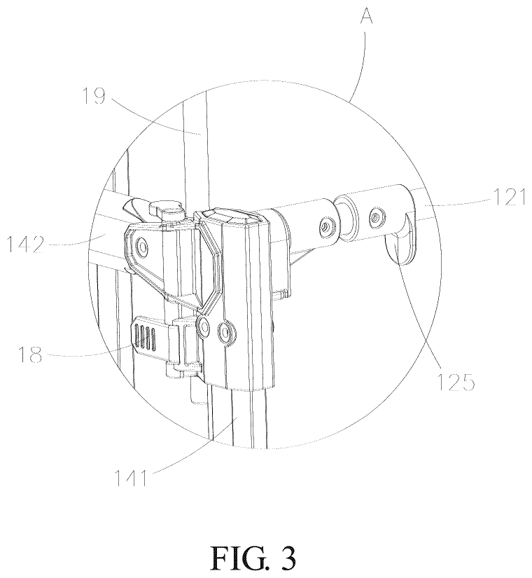

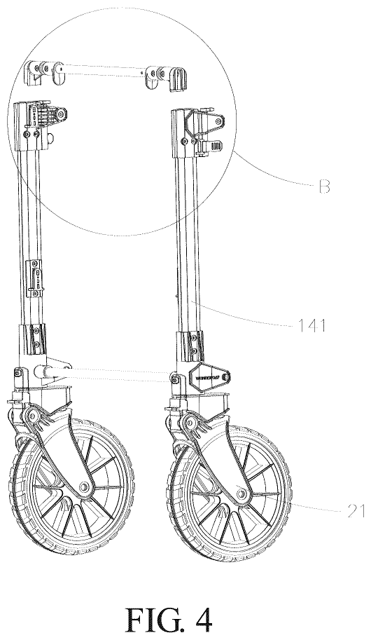

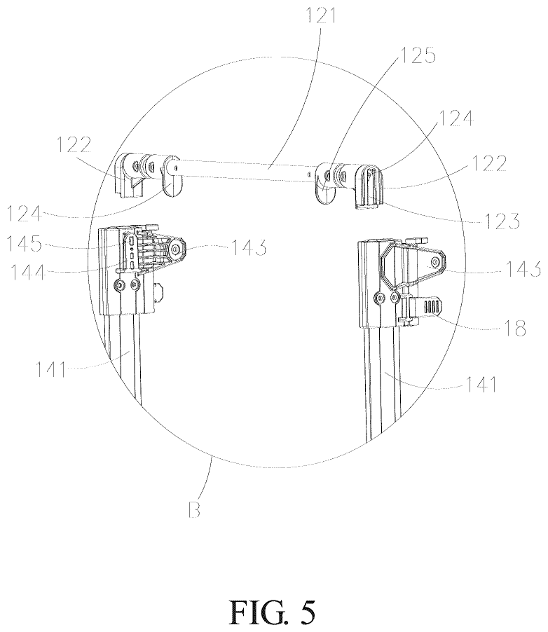

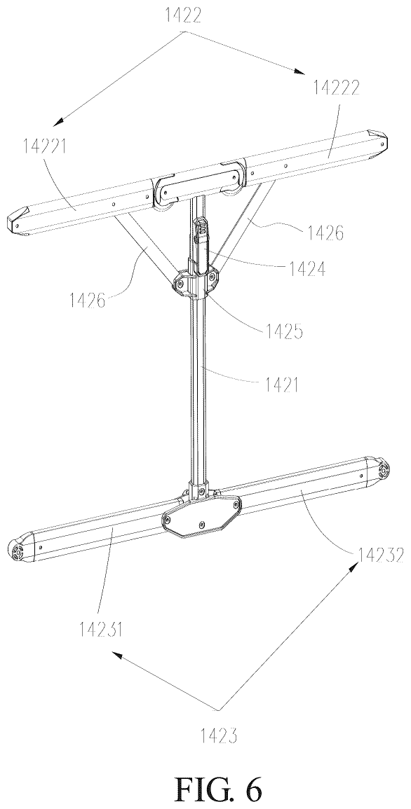

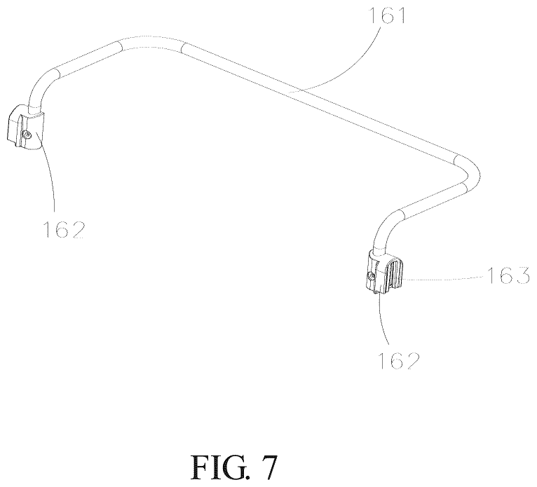

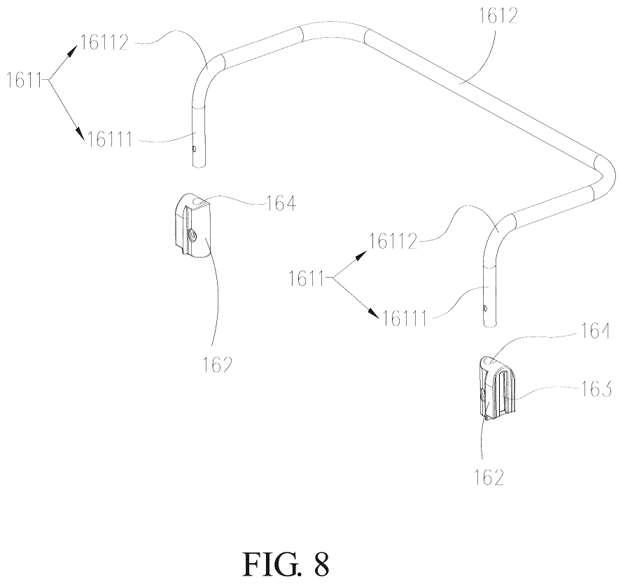

As shown in FIGS. 1 to 8, a children's stroller with easy disassembly and assembly features is provided. The stroller includes a frame 10, a wheel module 20 is disposed below the frame 10, and a stroller module 30 is disposed above the frame 10. The frame 10 moves through applying force to the stroller module 30 to move in corporation with the wheel module 20. The frame 10 includes a front support rod 11, a rear support rod 12, a first side frame 13, and a second side frame 14. The first side frame 13 and the second side frame 14 are parallel to each other and spaced apart from each other. Each upper ends of the first side frame 13 and the second side frame 14 has a connecting buckle 144, and the connecting buckles 144 on the same ends of the first side frame 13 and the second side frame 14 correspond to each other. Each of the ends of the front support rod 11 and the rear support rod 12 has a connecting groove 123 corresponding to the connecting buckle 144. The front support rod 11 and the rear support rod 12 are detachably disposed on the front side and the rear side of the first side frame 13 and the second side frame 14, respectively, through the corporation of the connecting groove 123 and the connecting buckle 144. A plurality of auxiliary brackets 17 are connected to and below the first side frame 13 and the second side frame 14. The auxiliary brackets 17 are transversely disposed between the first side frame 13 and the second side frame 14. The auxiliary brackets 17 are spaced apart from each other to form an accommodating space having an upward-facing opening on the frame 10. An auxiliary clamping buckle 15 and an auxiliary item-carrying frame 16 are disposed on the first side frame 13 and the second side frame 14. The auxiliary clamping buckle 15 is coaxially aligned with the connecting buckle 144 in a vertical direction. The auxiliary clamping buckle 15 is below the connecting buckle 144. The auxiliary item-carrying frame 16 is detachably connected to the auxiliary clamping buckle 15. When the auxiliary item-carrying frame 16 connects to the auxiliary clamping buckle 15, the auxiliary item-carrying frame 16 extends to the front side and/or the rear side of the frame 10 to form an auxiliary item-carrying space connected to the accommodating space. The first side frame 13 and the second side frame 14 are arranged in parallel to each other when assembling the frame 10. Afterwards, the front ends and the rear ends of the first side frame 13 and the second side frame 14 are connected to the front support rod 11 and the rear support rod 12 through the corporation of the connecting buckle 144 and the connecting groove 123. A plurality of auxiliary bracket 17 are connected to and below the first side frame 13 and the second side frame 14, and then the accommodating space with an upward-facing opening on the frame 10 is formed with cloth wrapping. The child is placed in the accommodating space when using the frame 10, and the child is protected by the frame 10 to prevent from falling out from the frame 10. Parents can move the frame 10 by applying a certain amount of pushing or pulling force to the stroller module 30, the pushing or pulling force are transmitted to the wheel module 20, and the wheel module 20 is rotated to drive the frame 10. In everyday scenarios, such as when carrying a child while shopping at a supermarket, managing an additional shopping cart or carrying a shopping basket may result in an excessive load. In this situation, the front support rod 11 or the rear support rod 12 may be disassembled to form a front opening or a rear opening on the accommodating space of the frame 10. Afterwards, the auxiliary item-carrying frame 16 is connected to the front side or the rear side of the frame 10 to form an auxiliary item-carrying space extending to the front side or the rear side on the frame 10. The shopping basket can be placed on the auxiliary item-carrying space to achieve a multifunctional use of the stroller. Similarly, it is common to carry camping supplies such as tents and food when taking children to the park to increase the time they spend in nature. However, when using a stroller and simultaneously and having to carry additional supplies, it can result in an excessive load that makes it difficult to care for the child. This greatly reduces the willingness of parents to take their children outdoors. The aforementioned method can also extend an auxiliary item-carrying space outward from the frame 10. On one hand, the auxiliary item-carrying space can meet the demand for carrying items on the stroller. On the other hand, the auxiliary item-carrying space does not occupy the entire accommodating space of the stroller. This allows for simultaneously accommodating both items and children, thereby enhancing the convenience of using the stroller. Furthermore, shapes and structures of the connecting buckle 144 and the auxiliary clamping buckle 15 are identical, so the front support rod 11 or the rear support rod 12 can be disassembled from the connecting buckle 144 and then connected to the auxiliary clamping buckle 15. As a result, the height of the front support rod 11 and/or the rear support rod 12 on the frame 10 may be reduced by half to make the stroller adaptable to various application scenarios and fulfilling parent-child interaction.

Both of the front support rod 11 and the rear support rod 12 have a rod body 121 and connectors 122 on both ends of the rod body 121. A connecting groove 123 is formed on an external side of the connector 122. A connecting guide recess is provided on a side of the connecting buckle 144. A connecting opening is formed below the connector 122, and the connecting opening connects to the connecting groove 123. The connector 122 is fitted onto the connecting buckle 144 from top to bottom through the connection guide recess via the connecting opening formed on the connecting groove 123. In this embodiment, connectors 122 are provided at both ends of the rod body 121. The connecting groove 123 are formed on external sides of the connector 122. By providing clamping openings above and below the connecting groove 123, the connector 122 can be fitted onto the connecting buckle 144 from the top to bottom to allow the front support rod 11 and the connector 122 be connected to the first side frame 13 and the second side frame 14. The connecting guide recess on the side of the connecting buckle 144 improves the smoothness of connecting or disconnecting the connector 122 to enhance the user experience.

An engaging groove 145 is formed at a side of the connecting buckle 144. An engaging block 124 which matches the engaging groove 145 is disposed in the connecting groove 123. An engaging transmission element 125 is fitted on the rod body 121. The engaging transmission element 125 is transmissively connected to the engaging block 124. The engaging transmission element 125 drives the engaging block 124 to connect to the engaging groove 145 or to detach from the engaging groove 145. In this embodiment, the front support rod 11 or the rear support rod 12 is engaged through the cooperation of the engaging block 124 and the engaging groove 145. By using the engaging transmission element 125 to move the engaging block 124, the connection or detachment between the engaging block 124 and the engaging groove 145 is achieved, so the front support rod 11 or the rear support rod 12 may be fixed or disassembled.

The auxiliary item-carrying frame 16 includes an item-carrying support rod 161 and connecting blocks 162 disposed at both ends of the item-carrying support rod 161. An auxiliary groove 163 is provided at a side of the connecting block 162 that faces the auxiliary clamping buckle 15. The item-carrying support rod 161 is connected to the auxiliary clamping buckle 15 through the auxiliary grooves 163 formed on the connecting blocks 162. In this embodiment, the connecting blocks 162 are disposed on both ends of the item-carrying support rod 161 to form the auxiliary item-carrying frame 16. By providing auxiliary groove 163 on the connecting block 162, the auxiliary item-carrying frame 16 can be connected to the auxiliary clamping buckle 15 through the auxiliary groove 163.

The item-carrying support rod 161 includes a connecting portion 1611 and a support portion 1612. The connecting portion 1611 includes an installing portion 16111 and a bending portion 16112. The bending portion 16112 is above the installing portion 16111. The bending portion 16112 extends towards one side of the installing portion 16111. The support portion 1612 is disposed on the side of the bending portion 16112 that extends outwardly. An installing groove 164 is provided on the connecting block 162, and the installing groove 164 has an opening facing upwardly. The installing portion 16111 is disposed in the installing groove 164 and connected to the installing block 162 by external screws. In this embodiment, the connecting portion 1611 and the support portion 1612 are integrally formed as one piece to make the item-carrying support rod 161. The connecting portion 1611 includes the installing portion 16111 and the bending portion 16112. The connecting portion 1611 is vertically inserted into the installing groove 164 on the connecting block 162, and then the installing portion 16111 is affixed in the installing groove 164 by external screws. The bending portion 16112 is bent to the front side or the rear side of the installing portion 16111 to affix the position and the orientation of the support portion 1612, thus connecting with the accommodating space while extending the auxiliary item-carrying space on the frame 10.

Both of the first side frame 13 and the second side frame 14 have two fixed brackets 141 and a movable bracket 142. The movable bracket 142 is disposed between the two fixed brackets 141. Sides of the two fixed brackets 141 on the side facing each other has assembly portions 143, and two ends of the movable bracket 142 are pivoted to the assembly portions 143. The two fixed brackets 141 on the same side are disposed opposite each other. A connecting buckle 144 is disposed on one side adjacent to the assembly portion 143 and positioned on the side of the two fixed brackets 141 opposite each other. In this embodiment, the first side frame 13 or the second side frame 14 is formed by disposing a movable bracket 142 between the two fixed brackets 141 to allow the movable bracket 142 cooperate with the fixed bracket 141, thus enabling the frame 10 to fold.

The movable bracket 142 has an “H” shape and includes a main support rod 1421. An upper movable bracket 1422(142) is disposed over the main support rod 1421, and a lower movable bracket 1423(142) is disposed below the main support rod 1421. A stroller folding button is disposed on the main support rod 1421 and is transmissively connected to the upper movable bracket 1422(142), and the frame 10 can be folded by pressing the stroller folding button. The movable bracket 142 has an “H” shape and is formed by the main support rod 1421, the upper movable bracket 1422(142), and the lower movable bracket 1423(142). Positions of the upper movable bracket 1422(142) and the lower movable bracket 1423(142) can be locked by the stroller folding button. By pressing the stroller folding button, the upper movable bracket 1422(142) and the lower movable bracket 1423142 can be unlocked and folded to facilitate the folding of the frame 10.

The upper movable bracket 1422(142) includes a first movable support rod 14221 and a second movable support rod 14222, and the lower movable bracket 1423(142) includes a third movable support rod 14231 and a fourth movable support rod 14232. The first movable support rod 14221 and the third movable support rod 14231 are both disposed on the front side of the main support rod 1421, and the second movable support rod 14222 and the fourth movable support rod 14232 are both disposed on the rear side of the main support rod 1421. The front ends of the first movable support rod 14221 and the third movable support rod 14231 are respectively hinged to the assembly portions 143, and the rear ends of the first movable support rod 14221 and the third movable support rod 14231 are respectively hinged to the front side of the main support rod 1421. The front ends of the second movable support rod 14222 and the fourth movable support rod 14232 are respectively hinged to the rear side of the main support rod 1421, and the rear ends of the second movable support rod 14222 and the fourth movable support rod 14232 are respectively hinged to the assembly portions 143. In this embodiment, the upper movable bracket 1422(142) is formed by the first movable support rod 14221 and the second movable support rod 14222, which facilitates stable support of the upper part of the frame 10 in a locked state. Similarly, the lower movable bracket 1423(142) is formed by the third movable support rod 14231 and the fourth movable support rod 14232, which facilitates stable support of the lower part of the frame 10 in the locked state. At the same time, the flexibility of the movable bracket 142 is improved to effectively reducing the footprint of the frame 10 after folding.

The stroller folding button includes a folding fixed switch 1424 and a folding movable block 1425. The folding fixed switch 1424 is affixed above the main support rod 1421, the folding movable block 1425 is movably fitted onto the main support rod 1421. Two folding control support rods 1426 respectively connect to the first movable support rod 14221 and the second movable support rod 14222, and the folding control support rods 1426 are disposed on the folding movable block 1425. One side of the folding movable block 1425 that faces the folding fixed switch 1424 has a folding groove, and a side of the folding fixed switch 1424 facing the folding movable block 1425 has a folding protrusion that fits into the folding groove. A control protrusion is disposed on a side of the folding fixed switch 1424 away from the folding protrusion, and the control folding protrusion is separated from the folding groove. When the folding movable block 1425 is connected to the folding fixed switch 1424, the folding protrusion is positioned in the folding groove, and the two folding control support rods 1426 respectively support the first movable support rod 14221 and the second movable support rod 14222 to unfold the frame 10. When the folding movable block 1425 is separated from the folding fixed switch 1424, the folding protrusion is separated from the folding groove. The folding movable block 1425 moves on the main support rod 1421 in a direction away from the folding fixed switch 1424 and simultaneously drives the two folding control support rods 1426 to move, which drives the first movable support rod 14221 and the second movable support rod 14222 to bend and fold to fold the frame 10. In this embodiment, the folding fixed switch 1424 and the folding movable block 1425 cooperate to lock or unlock the first movable support rod 14221 and the second movable support rod 14222, so the states of the first movable support rod 14221 and the second movable support rod 14222 can be controlled to achieve the unfolding or folding of the frame 10.

The wheel module 20 includes two front wheel assemblies 21 and two rear wheel assemblies 22. The two front wheel assemblies 21 are disposed independently, and each of the front wheel assemblies 21 has a first quick connector disposed above. The lower front ends of the first side frame 13 and second side frame 14 are disposed at first quick-connect slots that correspond with the first quick connectors. Each of the two front wheel assemblies 21 can be clipped to the sides of the front end of the frame 10 via the first quick connectors and the first quick-connect slots. A brake control rod connects the two rear wheel assemblies 22, and second quick connectors are disposed above each of the rear wheel assemblies 22. Second quick-connect slots that correspond with the second quick connectors are disposed below rear ends of the first side frame 13 and the second side frame 14. The two rear wheel assemblies 22 are respectively connected to both sides of the rear end of the frame 10 by engaging the second quick connectors with the second quick-connect slots. In this embodiment, the two front wheel assemblies 21 can be easily assembled or disassembled through the cooperation of the first quick connectors and the first quick-connect slots. Similarly, the two rear wheel assemblies 22 can be easily assembled or disassembled through the cooperation of the second quick connectors and the second quick-connect slots. When the frame 10 needs to be moved for an extended period, the wheel module 20 can be assembled with the frame 10 for mobility. When the frame 10 does not need to be moved for an extended period, the wheel module 20 can be removed to allow the frame 10 to rest directly on the ground and converted into a child's bed, thereby providing flexibility based on usage needs.

Additionally, a canopy lifting lock 18 is disposed on the fixed bracket 141 of the frame 10. A canopy bracket 19 can be installed over the frame 10 by the canopy lifting lock 18. A canopy can be installed by the canopy bracket 19. The canopy bracket 19 can be shrink by the canopy lifting lock 18 to adjust the height of the canopy bracket 19 in the vertical direction.

The above description is merely a preferred embodiment of the present disclosure and does not limit the scope of the claims. Any structural changes equivalent to those described in the disclosure or the figures, or direct/indirect application in other related technical fields, are all within the scope of this disclosure.

What is claimed is:

1. A children's stroller with easy disassembly and assembly features, comprising a frame (10), a wheel module (20) is disposed under the frame (10), and a stroller module (30) is disposed above the frame (10), the frame (10) moves through applying force to the stroller module (30) to move in corporation with the wheel module (20), characterized in that:
the frame comprises a front support rod (11), a rear support rod (12), a first side frame (13), and a second side frame (14), the first side frame (13) and the second side frame (14) are parallel to each other and spaced apart from each other, upper ends of the first side frame (13) and the second side frame (14) comprise connecting buckles (144), and the connecting buckles (144) on the same ends of the first side frame (13) and the second side frame (14) correspond to each other, the ends of the front support rod (11) and the rear support rod (12) comprise connecting grooves (123) corresponding to the connecting buckles (144), the front support rod (11) and the rear support rod (12) are detachably disposed on a front side and a rear side of the first side frame (13) and the second side frame (14), respectively, through the corporation of the connecting grooves (123) and the connecting buckles (144);
a plurality of auxiliary brackets (17) are connected to and below the first side frame (13) and the second side frame (14), the auxiliary brackets (17) are transversely disposed between the first side frame (13) and the second side frame (14), the auxiliary brackets (17) are spaced apart from each other to form an accommodating space having an upward-facing opening on the frame (10);
an auxiliary clamping buckle (15) and an auxiliary item-carrying frame (16) are disposed on the first side frame (13) and the second side frame (14), the auxiliary clamping buckle (15) is coaxially aligned with the connecting buckle (144) in a vertical direction, the auxiliary clamping buckle (15) is below the connecting buckle (144), the auxiliary item-carrying frame (16) is detachably connected to the auxiliary clamping buckle (15), when the auxiliary item-carrying frame (16) connects to the auxiliary clamping buckle (15), the auxiliary item-carrying frame (16) extends to a front side and/or a rear side of the frame (10) to form an auxiliary item-carrying space connected to the accommodating space.

2. The children's stroller with easy disassembly and assembly features as claimed in claim 1, characterized in that: both of the front support rod (11) and the rear support rod (12) comprise a rod body (121) and connectors (122) on both ends of the rod body (121), a connecting groove (123) is formed on an external side of the connector (122), a connecting guide recess is provided on a side of the connecting buckle (144), a connecting opening is formed below the connector (122), and the connecting opening connects to the connecting groove (123), the connector (122) is fitted onto the connecting buckle (144) from top to bottom through the connection guide recess via the connecting opening formed on the connecting groove (123).

3. The children's stroller with easy disassembly and assembly features as claimed in claim 2, characterized in that: an engaging groove (145) is formed at a side of the connecting buckle (144), an engaging block (124) which matches the engaging groove (145) is disposed in the connecting groove (123), an engaging transmission element (125) is fitted on the rod body (121), the engaging transmission element (125) is transmissively connected to the engaging block (124), the engaging transmission element (125) drives the engaging block (124) to connect to the engaging groove (145) or to detach from the engaging groove (145).

4. The children's stroller with easy disassembly and assembly features as claimed in claim 1, characterized in that: the auxiliary item-carrying frame (16) comprises an item-carrying support rod (161) and connecting blocks (162) disposed at both ends of the item-carrying support rod (161), an auxiliary groove (163) is provided at a side of the connecting block (162) that faces the auxiliary clamping buckle (15), the item-carrying support rod (161) is connected to the auxiliary clamping buckle (15) through the auxiliary grooves (163) formed on the connecting blocks (162).

5. The children's stroller with easy disassembly and assembly features as claimed in claim 4, characterized in that: the item-carrying support rod (161) comprises a connecting portion (1611) and a support portion (1612), the connecting portion (1611) comprises an installing portion (16111) and a bending portion (16112), the bending portion (16112) is above the installing portion (16111), the bending portion (16112) extends towards one side of the installing portion (16111), the support portion (1612) is disposed on the side of the bending portion (16112) that extends outwardly, an installing groove (164) is provided on the connecting block (162), and the installing groove (164) has an opening facing upwardly, the installing portion (16111) is disposed in the installing groove (164) and connected to the installing block (162) by external screws.

6. The children's stroller with easy disassembly and assembly features as claimed in claim 1, characterized in that: both of the first side frame (13) and the second side frame (14) comprise two fixed brackets (141) and a movable bracket (142), the movable bracket (142) is disposed between the two fixed brackets (141), sides of the two fixed brackets (141) on the side facing each other has assembly portions (143), and two ends of the movable bracket (142) are pivoted to the assembly portions (143), the two fixed brackets (141) on the same side are disposed opposite each other, a connecting buckle (144) is disposed on one side adjacent to the assembly portion (143) and positioned on the side of the two fixed brackets (141) opposite each other.

7. The children's stroller with easy disassembly and assembly features as claimed in claim 6, characterized in that: the movable bracket (142) has an H shape and comprises a main support rod (1421), an upper movable bracket (1422)(142) is disposed over the main support rod (1421), and a lower movable bracket (1423)(142) is disposed below the main support rod 1421, a stroller folding button is disposed on the main support rod (1421) and is transmissively connected to the upper movable bracket (1422)(142), and the frame (10) is folded by pressing the stroller folding button.

8. The children's stroller with easy disassembly and assembly features as claimed in claim 7, characterized in that: the upper movable bracket (1422)(142) comprises a first movable support rod (14221) and a second movable support rod (14222), and the lower movable bracket (1423)(142) comprises a third movable support rod (14231) and a fourth movable support rod (14232), the first movable support rod (14221) and the third movable support rod (14231) are both disposed on the front side of the main support rod (1421), and the second movable support rod (14222) and the fourth movable support rod (14232) are both disposed on the rear side of the main support rod (1421), front ends of the first movable support rod (14221) and the third movable support rod (14231) are respectively hinged to the assembly portions (143), and rear ends of the first movable support rod (14221) and the third movable support rod (14231) are respectively hinged to the front side of the main support rod (1421), front ends of the second movable support rod (14222) and the fourth movable support rod (14232) are respectively hinged to the rear side of the main support rod (1421), and rear ends of the second movable support rod (14222) and the fourth movable support rod (14232) are respectively hinged to the assembly portions (143).

9. The children's stroller with easy disassembly and assembly features as claimed in claim 8, characterized in that: the stroller folding button comprises a folding fixed switch (1424) and a folding movable block (1425), the folding fixed switch (1424) is affixed above the main support rod (1421), the folding movable block (1425) is movably fitted onto the main support rod (1421), two folding control support rods (1426) respectively connect to the first movable support rod (14221) and the second movable support rod (14222), and the folding control support rods (1426) are disposed on the folding movable block (1425), one side of the folding movable block (1425) facing the folding fixed switch (1424) has a folding groove, and a side of the folding fixed switch (1424) facing the folding movable block (1425) comprises a folding protrusion that fits into the folding groove, a control folding protrusion is disposed on a side of the folding fixed switch (1424) away from the folding protrusion, and the control folding protrusion is separated from the folding groove, when the folding movable block (1425) is connected to the folding fixed switch (1424), the folding protrusion is positioned in the folding groove, and the two folding control support rods (1426) respectively support the first movable support rod (14221) and the second movable support rod (14222) to unfold the frame (10), when the folding movable block (1425) is separated from the folding fixed switch (1424), the folding protrusion is separated from the folding groove, the folding movable block (1425) moves on the main support rod (1421) in a direction away from the folding fixed switch (1424) and simultaneously drives the two folding control support rods (1426) to move, which drives the first movable support rod (14221) and the second movable support rod (14222) to bend and fold to fold the frame (10).

10. The children's stroller with easy disassembly and assembly features as claimed in claim 1, characterized in that: the wheel module (20) comprises two front wheel assemblies (21) and two rear wheel assemblies (22), the two front wheel assemblies (21) are disposed independently, and each of the front wheel assemblies (21) has a first quick connector disposed above, lower front ends of the first side frame (13) and second side frame (14) are disposed at first quick-connect slots that correspond with the first quick connectors, each of the two front wheel assemblies (21) is clipped to the sides of the front end of the frame (10) via the first quick connectors and the first quick-connect slots, a brake control rod connects the two rear wheel assemblies (22), and second quick connectors are disposed above each of the rear wheel assemblies (22), second quick-connect slots that correspond with the second quick connectors are disposed below rear ends of the first side frame (13) and the second side frame (14), the two rear wheel assemblies (22) are respectively connected to both sides of the rear end of the frame (10) by engaging the second quick connectors with the second quick-connect slots.
